(19) United States
(12) Patent Application Publication
(10) Pub. No.: US 2017/0373487 A1
(43) Pub. Date: Dec. 28, 2017

(54) STARTING AND PROTECTING INDUCTION MOTORS

(71) Applicant: Mojtaba Rashvand, Tehran (IR)

(72) Inventor: Mojtaba Rashvand, Tehran (IR)

(21) Appl. No.: 15/698,476

(22) Filed: Sep. 7, 2017

Related U.S. Application Data
(60) Provisional application No. 62/384,721, filed on Sep. 8, 2016.

(51) Int. Cl. H02H 7/085; H02K 11/23; H01H 35/10; H02P 1/44

(52) U.S. Cl. CPC H02H 7/0856; H02P 1/445; H02K 11/23; H01H 35/10

(57) ABSTRACT

A method for starting and protecting an induction motor is disclosed. The method includes starting the induction motor, detecting an initialization fault associated with the induction motor, monitoring operation of the induction motor, detecting an operation fault while monitoring operation of the induction motor, and stopping the induction motor if the initialization fault or the operation fault is detected.

### CROSS-REFERENCE TO RELATED APPLICATION

This application claims the benefit of priority from pending U.S. Provisional Patent Application Ser. No. 62/384,721, filed on Sep. 8, 2016, and entitled “DRIVER AND PROTECTOR OF INDUCTION MOTORS BY SLIP,” which is incorporated herein by reference in its entirety.

### TECHNICAL FIELD

The present disclosure generally relates to induction motors, and particularly, to methods for starting and protecting induction motors by electronic circuits.

### BACKGROUND

An important problem of single-phase induction motors is the absence of a starting torque. To create a starting torque, an auxiliary coil is used, which is then removed from the circuit when the motor starts working. To activate and deactivate the auxiliary coil in single-phase induction motors, a mechanical centrifugal switch is used. The centrifugal switch may include a clutch and platinum. In this mechanism, when the motor speed reaches the desired amount, the auxiliary coil is deactivated. But centrifugal switches have their own problems and can cause damage on single-phase induction motors. For example, if the induction motor cannot rotate for any reason, the centrifugal switch is incapable of cutting the electricity current and the high current can damage the auxiliary coil and also the motor itself. In some cases, the binding of the clutch and also the large distance between the contacts of platinum centrifugal switches or the contacts that stick together prevent the keys from functioning, which can also damage the auxiliary coil and the motor. Single-phase induction motors also require protection against overload or under voltage.

In three-phase induction motors, there is no starting issue; however, protection is still required to protect against overload, under voltage, or phase separation. Different ways are used to reduce the initial current, such as the star-delta method. In this method, first the motor is launched in the star state, and after a certain time (determined by an industrial timer) the motor switches into the delta state. For this purpose, a power circuit, a complex control circuit and an industrial timer is required.

There is therefore a need for a simple method and circuit to start and protect induction motors, without a need for complex control procedure and circuitry. There is also a need for an integrated method that enables starting and protecting both single-phase and three-phase induction motors without adding complex procedures. A need also exists for a circuit that can perform operations needed for starting and protecting both single-phase and three-phase induction motors in different working conditions.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes an integrated method for starting and protecting an induction motor. The method may include starting the induction motor, detecting an initialization fault, monitoring operation of the induction motor, detecting an operation fault while monitoring operation of the induction motor, and stopping the induction motor if the initialization fault or the operation fault is detected. In some implementations, starting the induction motor may include using a first switch and a second switch. Furthermore, stopping the induction motor may include using the first switch and the second switch.

The above general aspect may include one or more of the following features. In some implementations, the initialization fault and the operation fault may include a speed of the induction motor at a given time after starting the induction motor. In some cases, the speed of the induction motor may include a value lower than a first speed threshold. In some cases, monitoring operation of the induction motor may include measuring a speed of the induction motor. In some implementations, measuring the speed of the induction motor may include measuring a voltage of a Hall effect sensor at a time lapse. In some examples, the Hall effect sensor may be placed on the induction motor. In some cases, each of the first switch and the second switch may include an electromechanical relay or a solid state relay. In addition, each of the first switch and the second switch may be controlled by a processing unit. In some implementations, the processing unit may include a microprocessor. In some cases, the induction motor may include a three-phase induction motor. In other cases, the induction motor may include a single-phase induction motor. In some implementations, the single-phase induction motor may include a main coil and an auxiliary coil.

In some examples, starting the single-phase induction motor may include applying an AC voltage to the single-phase induction motor, and activating the main coil and the auxiliary coil. In some cases, starting the single-phase induction motor may further include deactivating the auxiliary coil when a speed of the single-phase induction motor reaches a second speed threshold. In some implementations, the second speed threshold may include three quarters of a nominal speed of the single-phase induction motor. In some cases, activating the main coil may include connecting the main coil to the first switch. In some implementations, activating the auxiliary coil may include connecting the auxiliary coil to the second switch. In some implementations, deactivating the auxiliary coil may include disconnecting the auxiliary coil from the second switch. In some examples, stopping the single-phase induction motor may include deactivating the main coil and deactivating the auxiliary coil. In some implementations, deactivating the main coil may include disconnecting the main coil from the first switch.

In some cases, starting the three-phase induction motor may include activating a power supply contactor, and applying an AC voltage to the three-phase induction motor through the power supply contactor. In some examples, activating the power supply contactor may include connecting the power supply contactor to the first switch. In some implementations, stopping the three-phase induction motor may include deactivating the power supply contactor. In some examples, deactivating the power supply contactor may include disconnecting the power supply contactor from the first switch.

In some cases, starting the three-phase induction motor may include activating a main contactor and a star contactor at an initial moment, and activating a delta contactor and deactivating the star contactor when an initialization time passes, or when a speed of the three-phase induction motor reaches a third speed threshold. In some implementations, the third speed threshold may be set to a nominal speed of the three-phase induction motor. In some examples, activating the main contactor may include connecting the main contactor to the first switch. In some cases, activating the star contactor may include connecting the star contactor to the second switch. In some implementations, activating the delta contactor may include connecting the delta contactor to the second switch. In some cases, deactivating the star contactor may include disconnecting the star contactor from the second switch. In some examples, stopping the induction motor may include deactivating the main contactor. In some cases, deactivating the main contactor may include disconnecting the main contactor from the first switch.

In another general aspect, the present disclosure describes a circuit for starting and protecting an induction motor. In an implementation, the induction may motor include a three-phase induction motor, or a single-phase induction motor. In an example, the single-phase induction motor may include a main coil and an auxiliary coil. In some implementations, the circuit may include a processing unit, a power source, a Hall effect sensor, a plurality of switches, and a plurality of contactors. In a case, the processing unit may include a microprocessor. In some examples, the Hall effect sensor may measure a speed of the induction motor at a time lapse. In a configuration, the Hall effect sensor is placed on the induction motor. In some cases, the plurality of switches may include a first switch and a second switch. In some implementations, the first switch and the second switch may include an electromechanical relay or a solid state relay. In some examples, the plurality of switches may be controlled by the processing unit. In some cases, the plurality of contactors may include a main contactor, a star contactor, and a delta contactor. In some implementations, the plurality of contactors may be controlled by the processing unit. In some examples, the processing unit may be configured to perform a set of operations. The set of operations may include starting the induction motor, detecting an initialization fault, measuring a speed of the induction motor by the Hall effect sensor, detecting an operation fault while measuring the speed of the induction motor, and stopping the induction motor if the initialization fault or the operation fault is detected.

The above general aspect may include one or more of the following features. In some implementations, starting the single-phase induction motor may include connecting the power source to the single-phase induction motor, activating the main coil by connecting the main coil to the first switch, activating the auxiliary coil by connecting the auxiliary coil to the second switch, and deactivating the auxiliary coil by disconnecting the auxiliary coil from the second switch when a speed of the single-phase induction motor reaches a second speed threshold. In some examples, the second speed threshold may include three quarters of a nominal speed of the single-phase induction motor. In a case, the nominal speed may be stored in the processing unit.

In some implementations, starting the three-phase induction motor may include connecting the power source to the three-phase induction motor through the main contactor, activating the main contactor by connecting the main contactor to the first switch, activating the star contactor by connecting the star contactor to the second switch, activating the delta contactor by connecting the star contactor to the second switch, and deactivating the star contactor by disconnecting the star contactor from the second switch. In some examples, activating the delta contactor and deactivating the star contactor may be performed when an initialization time passes, or when speed of the three-phase induction motor reaches a third speed threshold. In some cases, the third speed threshold may include a nominal speed of the three-phase induction motor.

In some implementations, the initialization fault and the operation fault may include the speed of the induction motor at a given time after starting the induction motor. In some cases, the speed of the induction motor may include a value lower than a first speed threshold.

In some configurations, stopping the single-phase induction motor may includes deactivating the main coil and deactivating the auxiliary coil. In some implementations, deactivating the main coil may include disconnecting the main coil from the first switch. In some cases, stopping the three-phase induction motor may include deactivating the main contactor. In some examples, deactivating the main contactor may include disconnecting the main contactor from the first switch.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a flowchart illustrating an implementation of an integrated method for starting and protecting an induction motor.

FIG. 2 illustrates an implementation of a circuit configured to start and protect a single-phase induction motor.

FIG. 3 illustrates an implementation of a circuit configured to start and protect a three-phase induction motor, according to a direct starting method.

FIG. 4 illustrates an implementation of a circuit configured to start and protect a three-phase induction motor, according to a star-delta starting method.

FIG. 5 illustrates an implementation of a circuit configured to start and protect a single-phase induction motor and a three-phase induction motor.

### DETAILED DESCRIPTION

The following detailed description is presented to enable a person skilled in the art to make and use the methods and devices disclosed in exemplary implementations of the present disclosure. For purposes of explanation, specific nomenclature is set forth to provide a thorough understanding of the present disclosure. However, it will be apparent to one skilled in the art that these specific details are not required to practice the disclosed exemplary implementations. Descriptions of specific exemplary implementations are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Disclosed herein is an integrated method and circuit for both starting and protecting induction motors. The method and circuit may be used to start and protect a single-phase induction motor, as well as a three-phase induction motor. Starting the induction motors may include activating coils or contactors by using switches, and deactivating the coils or switches after an initialization time passes or the speed of the induction motors reaches a given threshold. Protecting the induction motors may include detecting an initialization fault (when the induction motor is started) or an operation fault (while the induction motor is operating), and stopping the induction motor when an initialization fault or an operation fault is detected.

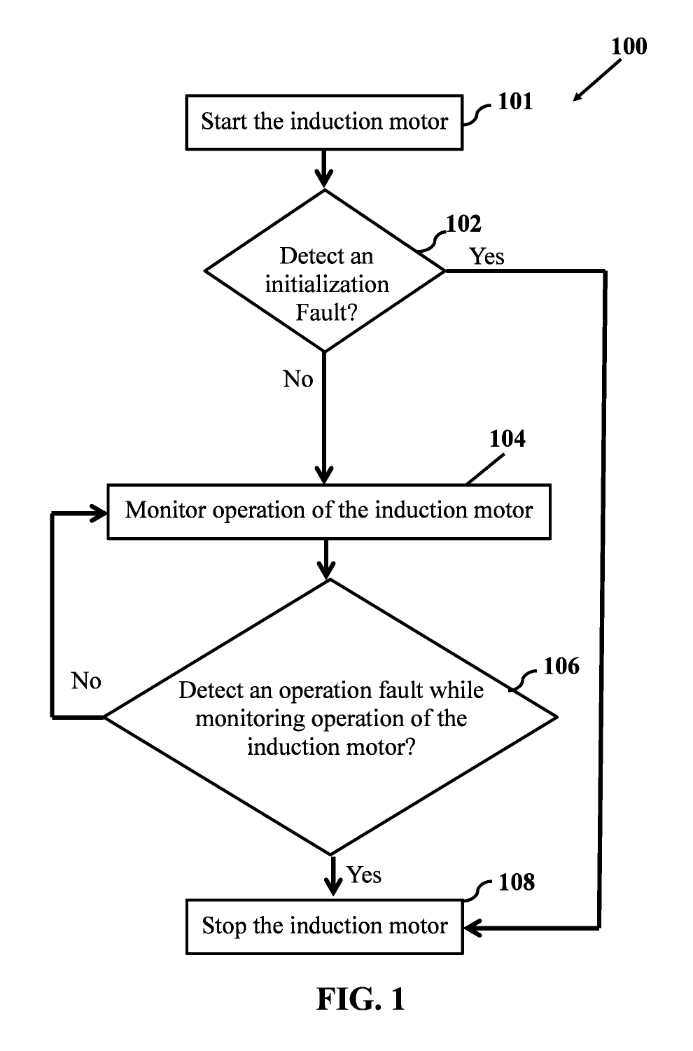

FIG. 1 illustrates an implementation of an integrated method 100 for starting and protecting an induction motor. The integrated method 100 may include starting the induction motor (step 101), detecting an initialization fault (step 102), monitoring operation of the induction motor (step 104), detecting an operation fault while monitoring operation of the induction motor (step 106), and stopping the induction motor if the initialization fault or the operation fault is detected (step 108). In some implementations, starting the induction motor (step 101) may include using a first switch and a second switch. In addition, stopping the induction motor (step 108) may include using the first switch and the second switch.

In some implementations, the initialization fault and the operation fault may include a speed of the induction motor at a given time after starting the induction motor (step 101). In some implementations, the speed of the induction motor may include a value lower than a speed threshold Nr. In an implementation, the speed threshold Nr may be calculated by the following equation:

Nr=(1−s)×Ns (Equation 1)

where, s is a slip threshold and Ns is a synchronous speed of the induction motor. In some implementations, induction motors may be designed to operate with low values of slip (about 0.02 to 0.05). Therefore, in some implementations of the integrated method 100, the slip threshold s may be set to about 0.05.

Referring again to FIG. 1, if an initialization fault is detected (step 102, Yes), the process 100 moves to stop the induction motor (step 108). If, however, an initialization fault is not detected (step 102, 100 No), the process 100 moves to monitor operation of the induction motor (step 104). Moving forward, if an operation fault is detected while monitoring operation of the induction motor (step 106, Yes), the induction motor is stopped (step 108). If an operation fault is not detected while monitoring operation of the induction motor (step 106, No), the process 100 returns to step 104 to continue to monitor the operation of the induction motor.

In some implementations, monitoring operation of the induction motor (step 104) may include measuring a speed of the induction motor. In some implementations, measuring the speed of the induction motor may include measuring a voltage of a Hall effect sensor at a time lapse, beginning from a given moment after starting the induction motor (step 101). In some examples, the Hall effect sensor may be placed on the induction motor. In a case, the Hall effect sensor may be placed near the shaft of the induction motor, and a magnet may be placed on the shaft. The sensor voltage may change once at each rotation of the shaft, as the magnet becomes close to the Hall effect sensor. In some implementations, the speed of the induction motor may be calculated by counting the number of voltage changes in the Hall effect sensor at every second.

In some examples, each of the first switch and the second switch may include an electromechanical relay or a solid state relay. Furthermore, each of the first switch and the second switch may be controlled by a processing unit. The processing unit may include a microprocessor.

In one implementation, the induction motor may include a three-phase induction motor. In another implementation, the induction motor may include a single-phase induction motor. The single-phase induction motor may include a main coil and an auxiliary coil. The single-phase induction motor may be started (step 1) by applying an AC voltage to the single-phase induction motor, and activating the main coil and the auxiliary coil. In some implementations, starting the single-phase induction motor (step) may further include deactivating the auxiliary coil when a speed of the single-phase induction motor reaches a speed threshold. The speed threshold may be set to three quarters of the nominal speed of the single-phase induction motor. The nominal speed of the single-phase induction motor may be stored in the processing unit. In some implementations, the voltage of the Hall effect sensor may be loaded to the processing unit to calculate the speed of the induction motor and detect the initialization fault or the operation fault. In some examples, the processing unit may generate an alarm (such as a visual alarm or an audible alarm) if the initialization fault or the operation fault is detected.

In some implementations, activating the main coil may include connecting the main coil to the first switch and activating the auxiliary coil may include connecting the auxiliary coil to the second switch. In some implementations in which electromechanical relays are used as the first switch or the second switch, a snubber circuit may also be included to protect the switches. In an implementation, a path to an AC power source may be provided to the main and auxiliary coils when connected to the corresponding switch, to activate each coil.

In some implementations, stopping the single-phase induction motor (step 108) may include deactivating the main coil and deactivating the auxiliary coil. Deactivating the main coil may include disconnecting the main coil from the first switch. Deactivating the auxiliary coil may include disconnecting the auxiliary coil from the second switch.

In another implementation, as noted above, the induction motor may include a three-phase induction motor. Starting the three-phase induction motor (step) may include activating a power supply contactor, and applying an AC voltage to the three-phase induction motor through the power supply contactor. The power supply contactor may be activated by connecting the power supply contactor to the first switch. In some implementations, stopping the three-phase induction motor (step 108) may include deactivating the power supply contactor. The power supply contactor may be deactivated by disconnecting the power supply contactor from the first switch.

In some implementations, starting the three-phase induction motor (step) may include activating a main contactor and a star contactor at an initial moment, and activating a delta contactor and deactivating the star contactor when an initialization time passes, or when a speed of the three-phase induction motor reaches a speed threshold. The speed threshold may be set to a nominal speed of the three-phase induction motor. The main contactor may be activated by connecting the main contactor to the first switch. The star contactor may be activated by connecting the star contactor to the second switch. The delta contactor may be activated by connecting the delta contactor to the second switch. Furthermore, the star contactor may be deactivated by disconnecting the star contactor from the second switch. In other words, the star contactor and the delta contactor may be connected to a same switch. Therefore, deactivating the star contactor by disconnecting it from the second switch may connect the delta contactor to the second switch, which may activate the delta contactor. Hence, in some implementations, deactivating the star contactor and activating the delta contactor may be simultaneously performed by a single command to the second switch from the processing unit.

In some examples, stopping the induction motor (step 108) may include deactivating the main contactor. The main contactor may be deactivated by disconnecting the main contactor from the first switch.

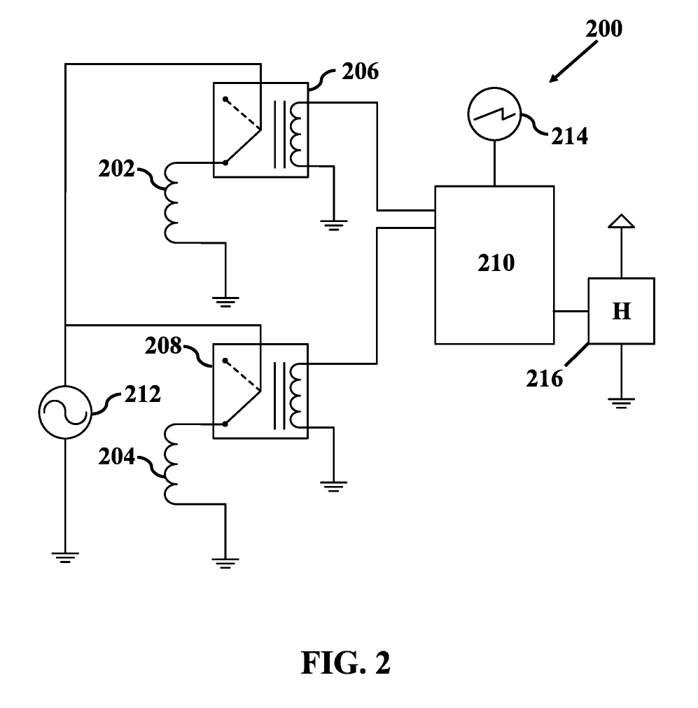

FIG. 2 depicts an implementation of a circuit 200 configured to start and protect a single-phase induction motor, according to an implementation of the integrated method 100. In some implementations, the single-phase induction motor may include a main coil 202 and an auxiliary coil 204. In some examples, starting the single-phase induction motor (step) may include applying an AC voltage to the single-phase induction motor, and activating the main coil 202 and the auxiliary coil 204. In some implementations, starting the single-phase induction motor (step) may further include deactivating the auxiliary coil 204 when a speed of the single-phase induction motor reaches a speed threshold. The speed threshold may be set to three quarters of the nominal speed of the single-phase induction motor.

The main coil 202 may be activated by connecting the main coil 202 to the first switch 206. The auxiliary coil 204 may be activated by connecting the auxiliary coil 204 to the second switch 208. In some implementations in which electromechanical relays are used as the first switch 206 or the second switch 208, a snubber circuit may also be included to protect the switches. In an implementation, a path to an AC power source 212 may be provided to the main and auxiliary coils 202 and 204 when connected to the corresponding switch, to activate each coil.

In some implementations, the first switch 206 and the second switch 208 may be controlled by the processing unit 210. The processing unit 210 may include a microprocessor. In an example, the nominal speed of the single-phase induction motor may be stored in the processing unit 210. In some implementations, the voltage of the Hall effect sensor 214 may be loaded to the processing unit 210 to calculate the speed of the induction motor and detect the initialization fault or the operation fault. In some examples, the processing unit 210 may generate an alarm 216 (such as a visual alarm or an audible alarm) if the initialization fault or the operation fault is detected.

In some examples, stopping the single-phase induction motor (step 108) may include deactivating the main coil 202 and deactivating the auxiliary coil 204. The main coil 202 may be deactivated by disconnecting the main coil 202 from the first switch 206. The auxiliary coil 204 may be deactivated by disconnecting the auxiliary coil 204 from the second switch 208.

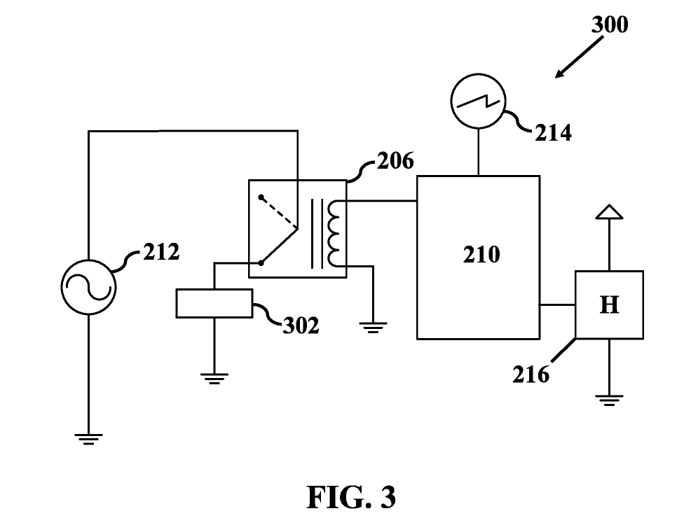

FIG. 3 depicts an implementation of a circuit 300 configured to start and protect a three-phase induction motor, according to an implementation of the integrated method 100. In some implementations, starting the three-phase induction motor (step) may include activating a power supply contactor 302, and applying an AC voltage to the three-phase induction motor through the power supply contactor 302. Starting the three-phase induction motor according to the implementation of FIG. 3 may also be referred to as “direct starting.” The power supply contactor 302 may be activated by connecting the power supply contactor 302 to the first switch 206. The first switch 206 may include an electromechanical relay, or a solid state relay and may be controlled by the processing unit 210.

In some implementations, stopping the three-phase induction motor (step 108) may include deactivating the power supply contactor 302. The power supply contactor may be deactivated by disconnecting the power supply contactor 302 from the first switch 206.

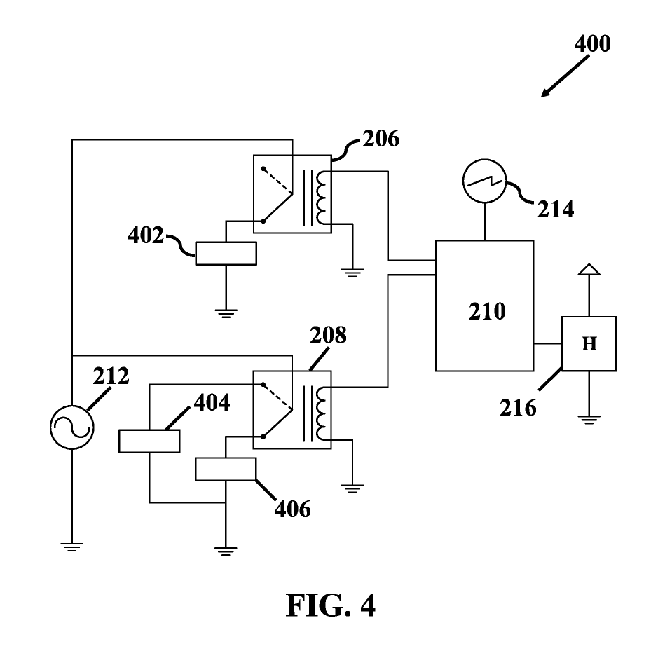

FIG. 4 depicts an implementation of a circuit 400 configured to start and protect a three-phase induction motor, according to an implementation of the integrated method 100. In some implementations, starting the three-phase induction motor (step) may include activating a main contactor 402 and a star contactor 404 at an initial moment, and activating a delta contactor 406 and deactivating the star contactor when an initialization time passes, or when a speed of the three-phase induction motor reaches a speed threshold. The speed threshold may be set to a nominal speed of the three-phase induction motor. Starting the three-phase induction motor according to the implementation of FIG. 4 may also be referred to as “star-delta starting.”

The main contactor 402 may be activated by connecting the main contactor 402 to the first switch 206. The first switch 206 may include an electromechanical relay or a solid state relay. The star contactor 404 may be activated by connecting the star contactor 404 to the second switch 208. The second switch 208 may include an electromechanical relay or a solid state relay. The delta contactor 406 may be activated by connecting the delta contactor to the second switch 208.

In some implementations, deactivating the star contactor 404 may include disconnecting the star contactor 404 from the second switch 208. In other words, in some examples, the star contactor 404 and the delta contactor 406 may be connected to a same switch. Therefore, deactivating the star contactor 404 by disconnecting it from the second switch 208 may connect the delta contactor 406 to the second switch 208, which may activate the delta contactor 406. In some implementations, the first switch 206 and the second switch 208 may be controlled by the processing unit 210. Hence, in some implementations, deactivating the star contactor 404 and activating the delta contactor 406 may be simultaneously performed by a single command to the second switch 208 from the processing unit 210.

In some examples, stopping the induction motor (step 108) may include deactivating the main contactor 402. The main contactor 402 may be deactivated by disconnecting the main contactor 402 from the first switch 206.

### EXAMPLE 1

### A Starter and Protector Circuit for a Single-Phase Induction Motor and a Three-Phase Induction Motor

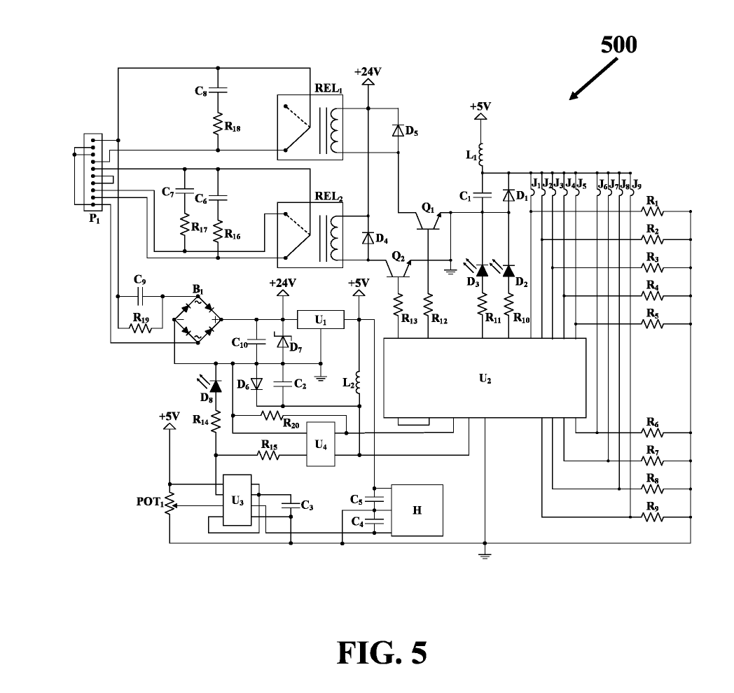

FIG. 5 illustrates an implementation of a circuit 500 configured to start and protect a single-phase induction motor and a three-phase induction motor, according to an implementation of the integrated method 100. TABLE 1 includes the description of elements that are used in the circuit 500.

TABLE 1
Description of elements that are used in the circuit 500

| Element | Description | | Value/Model | |
|---|---|---|---|---|
| R₁-R₉ | ¼ | W Resistor | 4.7 | kΩ |
| R₁₀-R₁₁ | ¼ | W Resistor | 220 | Ω |
| R₁₂-R₁₃ | ¼ | W Resistor | 1 | kΩ |
| R₁₄ | ¼ | W Resistor | 2.2 | kΩ |
| R₁₅ | ¼ | W Resistor | 1 | kΩ |
| R₁₆-R₁₈ | ¼ | W Resistor | 47 | Ω |
| R₁₉ | 1 | W Resistor | 100 | kΩ |
| R₂₀ | ¼ | W Resistor | 4.7 | kΩ |

| | | | |
|---|---|---|---|
| C₁-C₅ | Capacitor | 100 | nF |
| C₆-C₉ | 400 V Capacitor | 1 | μF |
| C₁₀ | 63 V Capacitor | 330 | μF |
| L₁-L₂ | Inductor | 100 | nH |

| | | |
|---|---|---|
| D₁, D₄, D₅, D₆ | Diode | 1N4007 |
| D₂, D₃, D₈ | Light emitting diode | LED3R-LED3G |
| D₇ | TVS diode | P6.5KE24A |
| Q₁, Q₂ | Transistor | BD137 |
| J₁-J₉ | Jumper | DS1027-2BB |
| REL₁, REL₂ | Electromechanical relay | HJQ-15F-1-S-Z |
| B₁ | 2 A Diode bridge | 2KBP04M |
| U₁ | Voltage regulator | 7805 |
| U₂ | Microcontroller | ATmega8 |
| U₃ | Dual op-amp | LM358 |
| U₄ | Optocoupler | SFH615-2 |
| P₁ | 10-pin Terminal | PHOENIX-10 PIN-RA |
| H | Hall effect sensor | UGN3503 |

In an implementation, both single-phase and three-phase induction motors can be connected to the circuit 500 through a terminal P₁. The coils or contactors of the induction motors can be connected to the first switch REL₁ and the second switch REL₂, according to the implementations of FIG. 2-FIG. 4. A first snubber circuit, including a resistor R₁₈ and a capacitor C₈, may be coupled with the first switch REL₁. A second snubber circuit, including a resistor R₁₆ and a capacitor C₆, and a third snubber circuit, including a resistor R₁₇ and a capacitor C₇, may be coupled with the second switch REL₂. The snubber circuits may protect the switches against possible voltage spikes. Since two elements may be simultaneously connected to the second switch REL₂ (for example, the star contactor 404 and the delta contactor 406 in the implementation of FIG. 4), two snubber circuits may be coupled to the second switch REL₂, whereas one snubber circuit may be sufficient to protect the first switch REL₁. In an example, a microcontroller U₂ drives the first switch REL₁ through a transistor Q₁ and the second switch REL₂ through a transistor Q₂. A freewheeling diode D₅ may be coupled with the first switch REL₁ to protect the transistor Q₁ against voltage spikes on the first switch REL₁. A freewheeling diode D₂ may be coupled with the second switch REL₂ to protect the transistor Q₂ against voltage spikes on the second switch REL₂. The transistor Q₁ may be connected to the microcontroller U₂ through a resistor R₁₂, to reduce the output current of the microcontroller U₂ that is injected to the transistor Q₁. The transistor Q₂ may be connected to the microcontroller U₂ through a resistor R₁₃, to reduce the output current of the microcontroller U₂ that is injected to the transistor Q₂. In an implementation, when the circuit 500 is connected to a power source through a terminal P₁, an input AC voltage is converted and reduced to about 5 v DC. The amplitude of the input AC voltage may be first reduced by an RC circuit, including a resistor R₁₉ and a capacitor C₉. The AC voltage may be then rectified by a diode bridge B₁. The rectified voltage may be converted to a 24 V DC voltage by a TVS diode D₇. Ripples of the 24 V DC voltage may be removed by a capacitor C₁₀ that couples the output of the diode bridge B₁ to the ground. The 24 V DC voltage may be reduced to a 5 V DC voltage by a voltage regulator U₁. The 5 V DC voltage may be further denoised by a denoising filter, including an inductor L₂, a capacitor C₂, and a diode D₆. The 5V DC voltage may feed a Hall effect sensor H and the microcontroller U₂. The sensor H may include three pins. A supply pin may be connected to the 5V DC voltage, a ground pin may be connected to the ground, and an output pin may include the output voltage of the sensor H. The signal on the output pin may be denoised by coupling the signal to the ground through a capacitor C₄, and the signal on the supply pin may be denoised by coupling the signal to the ground through a capacitor C₅. In the normal mode, the output voltage of the sensor H is about 2.5v. When a magnet becomes close to the backside of the sensor H, the output voltage of the sensor H increases. In an implementation, the output of the sensor H is connected to a first op-amp in the dual op-amp U₃. A capacitor C₃ may couple the dual op-amp U₃ to the ground to denoise the signals of the dual op-amp U₃. The first op-amp operates in the positive buffer mode. In an example, the output of the first op-amp is connected to the positive input of a second op-amp in the dual op-amp U₃. A potentiometer POT₁, supplied by the 5 V DC voltage, may be connected to the negative input of the second op-amp. The second op-amp may be used in the comparator mode. The sensitivity of the sensor H can be changed by changing the sensitivity of the potentiometer POT₁. In an example, the output of the second op-amp may be connected to the input of an optocoupler U₄. The output current of the second op-amp and the input current of the optocoupler U₄ may be reduced by coupling the second op-amp output and the optocoupler U₄ input to the ground through resistors R₁₄ and R₁₅. The output of the optocoupler U₄ may be connected to the timer/counter input of the microcontroller U₂. At each rotation of the induction motor, the output of the Hall effect sensor H is activated, causing the timer/counter input of the microcontroller U₂ to increment. A light emitting diode D₈ may be connected to the optocoupler U₄ input to monitor the rotation of the induction motor by emitting light upon each counting incident. A pull-down resistor R₂₀ may couple the optocoupler U₄ output to the ground.

In an implementation, the circuit 500 includes two sets of jumpers. The first set includes jumpers J₁-J₄ that are configured to set the speed of the induction motor. The second set includes jumpers J₅-J₉ that are configured to set the type of the induction motor, which includes a single-phase or a three-phase induction motor. The jumpers may be connected to the 5 V DC voltage. The 5 V DC voltage may be denoised by a denoising filter, including an inductor L₁, a capacitor C₁, and a diode D₁. The jumpers J₁-J₉ may be coupled to the ground through pull-down resistors R₁-R₉. In an example, the steps of starting and protecting the induction motor are determined by the microcontroller U₂, based on the type of the induction motor. The direction of the rotation of the induction motors can be changed by changing the adjustments of the terminal P₁. In one implementation, the sensor H is placed on the shaft of the induction motor and measures the speed of the induction motor. In an implementation, the microcontroller U₂ controls the induction motor via commands that are sent to the first switch REL₁ and the second switch REL₂, according to the measured speed. The microcontroller U₂ may send a command to a light emitting diode D₂ to emit light, if an initialization fault or an operation fault is detected. The light emitting diode D₂ may be connected to the microcontroller U₂ through a resistor R₁₀, to reduce the amount of current flowing through the light emitting diode D₂. In addition, the microcontroller U₂ may send a command to a light emitting diode D₃ to emit light, if no fault is detected. The light emitting diode D₃ may be connected to the microcontroller U₂ through a resistor R₁₁, to reduce the amount of current flowing through the light emitting diode D₃.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method for starting and protecting an induction motor, the method comprising:
starting an induction motor using a first switch and a second switch;
detecting an initialization fault associated with the induction motor;
monitoring operation of the induction motor;
detecting an operation fault while monitoring operation of the induction motor; and
stopping the induction motor using the first switch and the second switch if the initialization fault or the operation fault is detected.

2. The method of claim 1, wherein the initialization fault and the operation fault include a speed of the induction motor at a given time after starting the induction motor, wherein the speed of the induction motor includes a value lower than a first speed threshold, wherein the first speed threshold is calculated by an operation defined by:
Nᵣ=(1−s)×Nₛ
where, Nᵣ is the first speed threshold, s is a slip threshold, and Nₛ is a synchronous speed of the induction motor.

3. The method of claim 1, wherein the monitoring operation of the induction motor includes measuring a speed of the induction motor.

4. The method of claim 3, wherein measuring the speed of the induction motor includes measuring a voltage of a Hall effect sensor at a time lapse, the time lapse starting at a given moment after starting the induction motor, wherein the Hall effect sensor is placed on the induction motor.

5. The method of claim 1, wherein each of the first switch and the second switch includes an electromechanical relay or a solid state relay, wherein each of the first switch and the second switch is controlled by a processing unit, and the processing unit includes a microprocessor.

6. The method of claim 1, wherein the induction motor includes a three-phase induction motor, or a single-phase induction motor.

7. The method of claim 6, wherein the induction motor includes the single-phase induction motor, the single-phase induction motor includes a main coil and an auxiliary coil, and starting the single-phase induction motor includes:
applying an AC voltage to the single-phase induction motor; and
activating the main coil and the auxiliary coil.

8. The method of claim 7, wherein starting the single-phase induction motor further includes deactivating the auxiliary coil when a speed of the single-phase induction motor reaches a second speed threshold, the second speed threshold including three quarters of a nominal speed of the single-phase induction motor.

9. The method of claim 8, wherein:
activating the main coil includes connecting the main coil to the first switch;
activating the auxiliary coil includes connecting the auxiliary coil to the second switch; and
deactivating the auxiliary coil includes disconnecting the auxiliary coil from the second switch.

10. The method of claim 9, wherein stopping the single-phase induction motor includes:
deactivating the main coil by disconnecting the main coil from the first switch; and
deactivating the auxiliary coil.

11. The method of claim 6, wherein the induction motor includes a three-phase induction motor and starting the three-phase induction motor includes:
activating a power supply contactor; and
applying an AC voltage to the three-phase induction motor through the power supply contactor.

12. The method of claim 11, wherein activating the power supply contactor includes connecting the power supply contactor to the first switch.

13. The method of claim 12, wherein stopping the three-phase induction motor includes deactivating the power supply contactor by disconnecting the power supply contactor from the first switch.

14. The method of claim 6, wherein starting the three-phase induction motor includes:
activating a main contactor and a star contactor; and
activating a delta contactor and deactivating the star contactor when an initialization time passes, or when a speed of the induction motor reaches a third speed threshold, the third speed threshold including a nominal speed of the three-phase induction motor.

15. The method of claim 14, wherein:
activating the main contactor includes connecting the main contactor to the first switch;
activating the star contactor includes connecting the star contactor to the second switch;
activating the delta contactor includes connecting the delta contactor to the second switch; and
deactivating the star contactor includes disconnecting the star contactor from the second switch.

16. The method of claim 15, wherein stopping the induction motor includes deactivating the main contactor by disconnecting the main contactor from the first switch.

17. A circuit for starting and protecting an induction motor, the circuit comprising:
a processing unit including a microprocessor;
a power source;
a Hall effect sensor located on the induction motor and configured to measure a speed of the induction motor;
a plurality of switches controlled by the processing unit and including a first switch and a second switch, the first switch and the second switch including an electromechanical relay or a solid state relay; and
a plurality of contactors controlled by the processing unit and including a main contactor, a star contactor, and a delta contactor,
wherein the processing unit is configured to perform a set of operations including:
starting the induction motor;
detecting an initialization fault associated with the induction motor;
measuring a speed of the induction motor by the Hall effect sensor;
detecting an operation fault while measuring the speed of the induction motor; and
stopping the induction motor if the initialization fault or the operation fault is detected.

18. The circuit of claim 17, wherein the induction motor includes a three-phase induction motor or a single-phase induction motor.

19. The circuit of claim 18, wherein the induction motor includes the single-phase induction motor including a main coil and an auxiliary coil and starting the single-phase induction motor includes:
connecting the power source to the single-phase induction motor;
activating the main coil by connecting the main coil to the first switch;
activating the auxiliary coil by connecting the auxiliary coil to the second switch; and
deactivating the auxiliary coil by disconnecting the auxiliary coil from the second switch when a speed of the single-phase induction motor reaches a first speed threshold, the first speed threshold including three quarters of a nominal speed of the single-phase induction motor, wherein the nominal speed is stored in the processing unit.

20. The circuit of claim 18, wherein the induction motor includes a three-phase induction motor and starting the three-phase induction motor includes:
connecting the power source to the three-phase induction motor through the main contactor;
activating the main contactor by connecting the main contactor to the first switch;
activating the star contactor by connecting the star contactor to the second switch;
activating the delta contactor by connecting the delta contactor to the second switch; and
deactivating the star contactor by disconnecting the star contactor from the second switch,
wherein activating the delta contactor and deactivating the star contactor are performed when an initialization time passes, or when speed of the three-phase induction motor reaches a second speed threshold, the second speed threshold including a nominal speed of the three-phase induction motor.

21. The circuit of claim 17, wherein the initialization fault and the operation fault include the speed of the induction motor at a given time after starting the induction motor, the speed of the induction motor including a value lower than a third speed threshold, wherein the third speed threshold is calculated by an operation defined by:
Nᵣ=(1−s)×Nₛ
where Nᵣ is the first speed threshold, s is a slip threshold, and Nₛ is a synchronous speed of the induction motor.

22. The circuit of claim 18, wherein the induction motor includes the single-phase induction motor and stopping the single-phase induction motor includes deactivating the main coil by disconnecting the main coil from the first switch and deactivating the auxiliary coil.

23. The circuit of claim 18, wherein the induction motor includes a three-phase induction motor and stopping the three-phase induction motor includes deactivating the main contactor by disconnecting the main contactor from the first switch.
